(19) United States
(12) Patent Application Publication
(10) Pub. No.: US 2024/0036565 A1
(43) Pub. Date: Feb. 1, 2024

(54) REMOTE CABIN CONTROLS

(71) Applicant: GM Cruise Holdings LLC, San Francisco, CA (US)

(72) Inventors: Theresa Foy, San Francisco, CA (US); Leah Meyerholtz, San Francisco, CA (US); Soleil Phan, San Francisco, CA (US); Qingxuan Li, San Mateo, CA (US); Jyothi Babu Araja, San Francisco, CA (US); David Shuckerow, Seattle, WA (US); Christopher Warren, Seattle, WA (US); MinJie Tong, Issaquah, WA (US)

(73) Assignee: GM Cruise Holdings LLC, San Francisco, CA (US)

(21) Appl. No.: 17/939,951

(22) Filed: Sep. 7, 2022

(30) Foreign Application Priority Data
Jul. 26, 2022 (IN) 202241/042,849
Jul. 26, 2022 (IN) 202241042849

(51) Int. Cl. G05D 1/00; B60W 50/00; H04L 9/40; H04W 4/40

(52) U.S. Cl. CPC G05D 1/0011; B60W 50/0098; H04L 63/0892; H04W 4/40; B60W 2050/0083; B60W 2556/45; G05D 2201/0212; G05D 2201/0213

(57) ABSTRACT

There is disclosed an autonomous vehicle (AV), including an AV chassis comprising a drive system and a cabin comprising a plurality of cabin controls; an AV controller, including a processor circuit and a memory, wherein the memory includes instructions to instruct the processor circuit to operate the drive system in a fully autonomous configuration; actuators to electronically operate the cabin controls; a communication circuit with wireless communication capability; and instructions encoded within the memory to further instruct the processor circuit to: receive a remote cabin control command; and in response to the remote cabin control command, operate a cabin control.

### PRIORITY APPLICATION

The present application claims priority to India Provisional Patent Application, having the same title, with serial no. 202241/042,849 (the '849 application), and filed on Jul. 26, 2022. The '849 application is hereby incorporated by reference in its entirety.

### FIELD OF THE SPECIFICATION

The present disclosure relates generally to autonomous vehicles (AVs), and more particularly, though not exclusively, to remote cabin controls for an AV.

### BACKGROUND

AVs, also known as self-driving cars, and driverless vehicles, are vehicles that use multiple sensors to sense the environment and move without human input. Automation technology in the AVs enables the vehicles to drive on roadways and to perceive the vehicle's environment accurately and quickly, including obstacles, signs, and traffic lights. The vehicles may be used to pick up passengers and drive the passengers to selected destinations. The vehicles may also be used to pick up packages and/or other goods and deliver the packages and/or goods to selected destinations.

### SUMMARY

There is disclosed an AV, comprising an AV chassis comprising a drive system and a cabin comprising a plurality of cabin controls; an AV controller, comprising a processor circuit and a memory, wherein the memory includes instructions to instruct the processor circuit to operate the drive system in a fully autonomous configuration; actuators to electronically operate the cabin controls; a communication circuit with wireless communication capability; and instructions encoded within the memory to further instruct the processor circuit to: receive a remote cabin control command; and in response to the remote cabin control command, operate a cabin control.

### BRIEF DESCRIPTION OF THE DRAWINGS

The present disclosure is best understood from the following detailed description when read with the accompanying FIGURES. In accordance with the standard practice in the industry, various features are not necessarily drawn to scale, and are used for illustration purposes only. Where a scale is shown, explicitly or implicitly, it provides only one illustrative example. In other embodiments, the dimensions of the various features may be arbitrarily increased or reduced for clarity of discussion. Furthermore, the various block diagrams illustrated herein disclose only one illustrative arrangement of logical elements. Those elements may be rearranged in different configurations, and elements shown in one block may, in appropriate circumstances, be moved to a different block or configuration.

FIG. 1 is a block diagram of selected elements of an AV system.

FIG. 2 is a block diagram of selected elements of an AV controller.

FIG. 3 is a block diagram of selected elements of an AV system.

FIG. 4 is a flow chart of selected elements of a method of providing services via an onboard assistant.

FIG. 5 is a block diagram of selected elements of an AV.

FIG. 6 is a flowchart of a method of providing remote access to cabin controls.

FIG. 7 is a block diagram of selected elements of a hardware platform.

### DETAILED DESCRIPTION

Overview

The following disclosure provides many different embodiments, or examples, for implementing different features of the present disclosure. Specific examples of components and arrangements are described below to simplify the present disclosure. These are, of course, merely examples and are not intended to be limiting. Further, the present disclosure may repeat reference numerals and/or letters in the various examples. This repetition is for the purpose of simplicity and clarity and does not in itself dictate a relationship between the various embodiments and/or configurations discussed. Different embodiments may have different advantages, and no particular advantage is necessarily required of any embodiment.

AVs and vehicles with semi-autonomous features like automatic driver assist systems (ADAS) may include features, such as an onboard assistant. Onboard assistants may handle a range of user interactions, including emergency and non-emergency situations. For example, an onboard assistant may provide a button that a driver or passenger may press to be placed in contact with a service center. Service agents may then speak with the driver or passenger and help address issues or resolve concerns. The onboard assistant may also receive sensor data from the vehicle, and in certain situations may automatically place a call. For example, a call may be placed automatically in the case of a collision, mechanical failure, law enforcement interaction (e.g., the car was pulled over), obstruction, dangerous weather conditions, or similar.

One use case of an AV includes operating a fleet of ride-hail vehicles. These may be ride-hail vehicles that operate without a human driver. As used herein, AV supported ride-hail services may include other services, such as ride-share services and delivery services.

An end user for ride-hail services may install a mobile app on his or her cellular phone or mobile device and may provide profile and/or billing information. Depending on the passenger's privacy preferences, he or she may share additional information that may be used to customize or personalize the ride experience. When the end user needs to go somewhere, he or she may use the ride-hail app to request a ride with a ride-hail vehicle, including a desired destination. The AV operator may have a fleet of ride-hail vehicles and may dispatch a ride-hail vehicle to the end user's destination to pick the passenger up and take him or her to the desired destination.

In the context of a ride-hail vehicle service, an onboard assistant may assume additional significance. As some users may not be familiar or accustomed to ride-hail vehicle services, many users may initially find it unsettling to ride in a car without a human operator, and that may in fact lack human driving equipment altogether (e.g., it may lack a steering wheel, accelerator, brake pedals, etc.). In these cases, the onboard assistant may constitute the sole or at least primary person-to-person interaction for the passenger.

A passenger of a ride-hail vehicle may be provided with onboard controls that may be used to control various cabin systems. However, it may also be advantageous to provide an ability for the AV operator to remotely control certain aspects of the cabin. These remote cabin controls may be managed by a human, but they may be operated remotely. In most cases, the passenger or person on site will manage the controls manually, but in some cases, the onsite control may be supplemented or supplanted by remote control.

The foregoing may be used to build or embody several example implementations, according to the teachings of the present specification. Some example implementations are included here as non-limiting illustrations of these teachings.

Systems and methods for remote cabin controls will now be described with more particular reference to the attached FIGURES.

Exemplary AV

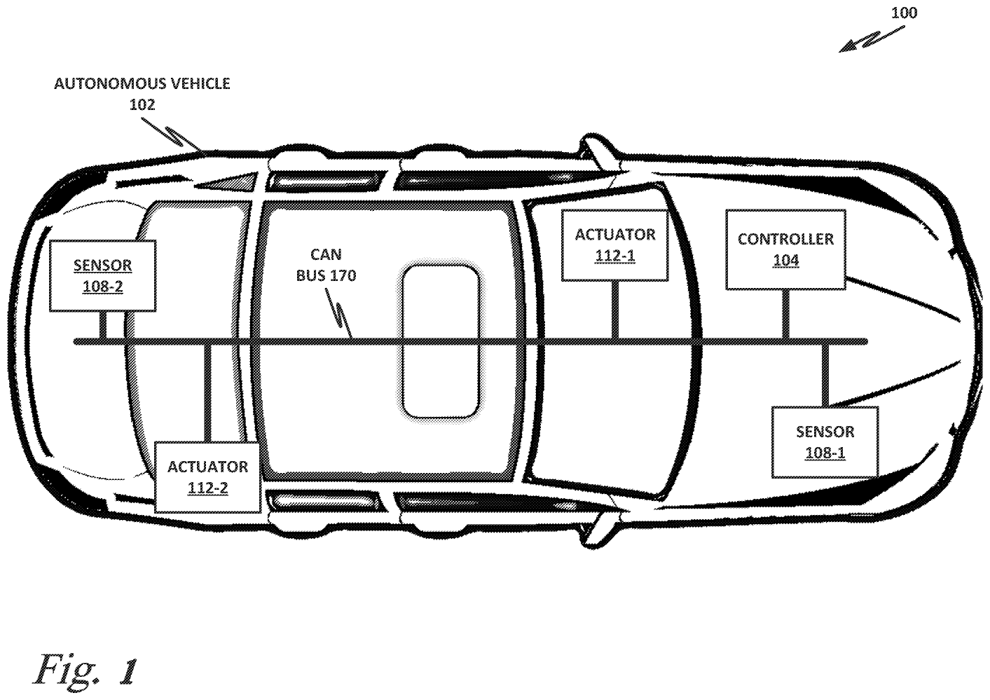

FIG. 1 is a block diagram 100 illustrating an exemplary AV 102. AV 102 may be, for example, an automobile, car, truck, bus, train, tram, funicular, lift, or similar. AV 102 could also be an autonomous aircraft (fixed wing, rotary, or tiltrotor), ship, watercraft, hover craft, hydrofoil, buggy, cart, golf cart, recreational vehicle, motorcycle, off-road vehicle, three- or four-wheel all-terrain vehicle, or any other vehicle. Except to the extent specifically enumerated in the appended claims, the present specification is not intended to be limited to a particular vehicle or vehicle configuration.

In this example, AV 102 includes one or more sensors, such as sensor 108-1 and sensor 108-2. Sensors 108 may include, by way of illustrative and non-limiting example, localization and driving sensors such as photodetectors, cameras, radio direction and ranging (RADAR), sound navigation and ranging (SONAR), light direction and ranging (LIDAR), GPS, inertial measurement units (IMUs), synchros, accelerometers, microphones, strain gauges, pressure monitors, barometers, thermometers, altimeters, wheel speed sensors, computer vision systems, biometric sensors for operators and/or passengers, or other sensors. In some embodiments, sensors 108 may include cameras implemented using high-resolution imagers with fixed mounting and field of view. In further examples, sensors 108 may include LIDARs implemented using scanning LIDARs. Scanning LIDARs have a dynamically configurable field of view that provides a point-cloud of the region intended to scan. In still further examples, sensors 108 includes RADARs implemented using scanning RADARs with dynamically configurable field of view. Embodiments may include a suite of sensors that collect data about the surrounding environment, which may include, by way of illustrative and non-limiting example, a pressure sensor that detects a flat tire on the vehicle. Additional sensors could also include collision sensors, environmental sensors that may detect adverse weather conditions, internal or external cameras that may detect obstructions or dangerous situations (e.g., someone or something is blocking the AV or otherwise threatening the AV), the presence of rain, fog, smoke, and others. In the same or a different embodiment, sensors may be used to identify a rider sentiment and enable an appropriate response to be provided based on the rider sentiment.

AV 102 may further include one or more actuators 112. Actuators 112 may be configured to receive signals and to carry out control functions on AV 102. Actuators 112 may include switches, relays, or mechanical, electrical, pneumatic, hydraulic, or other devices that control the vehicle. In various embodiments, actuators 112 may include steering actuators that control the direction of AV 102, such as by turning a steering wheel, or controlling control surfaces on an air or watercraft. Actuators 112 may further control motor functions, such as an engine throttle, thrust vectors, or others. Actuators 112 may also include controllers for speed, such as an accelerator. Actuators 112 may further operate brakes, or braking surfaces. Actuators 112 may further control headlights, indicators, warnings, a car horn, cameras, or other systems or subsystems that affect the operation of AV 102.

A controller 104 may provide the main control logic for AV 102. Controller 104 is illustrated here as a single logical unit and may be implemented as a single device such as an electronic control module (ECM) or other. In various embodiments, one or more functions of controller 104 may be distributed across various physical devices, such as multiple ECMs, one or more hardware accelerators, artificial intelligence (AI) circuits, or other.

Controller 104 may be configured to receive from one or more sensors 108 data to indicate the status or condition of AV 102, as well as the status or condition of certain ambient factors, such as traffic, pedestrians, traffic signs, signal lights, weather conditions, road conditions, or others. Based on these inputs, controller 104 may determine adjustments to be made to actuators 112. Controller 104 may determine adjustments based on heuristics, lookup tables, AI, pattern recognition, or other algorithms.

Various components of AV 102 may communicate with one another via a bus, such as controller area network (CAN) bus 170. CAN bus 170 is provided as an illustrative embodiment, but other types of buses may be used, including wired, wireless, fiberoptic, infrared, WiFi, Bluetooth, dielectric waveguides, or other types of buses. Bus 170 may implement any suitable protocol. Bus 170 may also enable controller 104, sensors 108, actuators 112, and other systems and subsystems of AV 102 to communicate with external hosts, such as internet-based hosts. In some cases, AV 102 may form a mesh or other cooperative network with other AVs, which may allow sharing of sensor data, control functions, processing ability, or other resources.

Controller 104 may control the operations and functionality of AV 102, or one or more other AVs. Controller 104 may receive sensed data from sensors 108, and make onboard decisions based on the sensed data. In some cases, controller 104 may also offload some processing or decision making, such as to a cloud service or accelerator. In some cases, controller 104 is a general-purpose computer adapted for I/O communication with vehicle control systems and sensor systems. Controller 104 may be any suitable computing device. An illustration of a hardware platform is shown in FIG. 8, which may represent a suitable computing platform for controller 104. In some cases, controller 104 may be connected to the internet via a wireless connection (e.g., via a cellular data connection). In some examples, controller 104 is coupled to any number of wireless or wired communication systems. In some examples, controller 104 is coupled to one or more communication systems via a mesh network of devices, such as a mesh network formed by AVs.

According to various implementations, AV 102 may modify and/or set a driving behavior in response to parameters set by vehicle passengers (e.g., via a passenger interface) and/or other interested parties (e.g., via a vehicle coordinator or a remote expert interface). Driving behavior of an AV may be modified according to explicit input or feedback (e.g., a passenger specifying a maximum speed or a relative comfort level), implicit input or feedback (e.g., a passenger's heart rate), or any other suitable data or manner of communicating driving behavior preferences.

AV 102 is illustrated as a fully autonomous automobile but may additionally or alternatively be any semi-autonomous or fully autonomous vehicle. In some cases, AV 102 may switch between a semi-autonomous state and a fully autonomous state and thus, some AVs may have attributes of both a semi-autonomous vehicle and a fully autonomous vehicle depending on the state of the vehicle.

AV 102 may take on other forms, including by way of illustrative and non-limiting example, personal vehicles (which may be fully autonomous, or provide hybrid autonomous/driver assist modes), automated cargo vehicles, delivery drones, autonomous trains, autonomous aircraft, or similar. Any such vehicle may benefit from an onboard assistant as described in this specification.

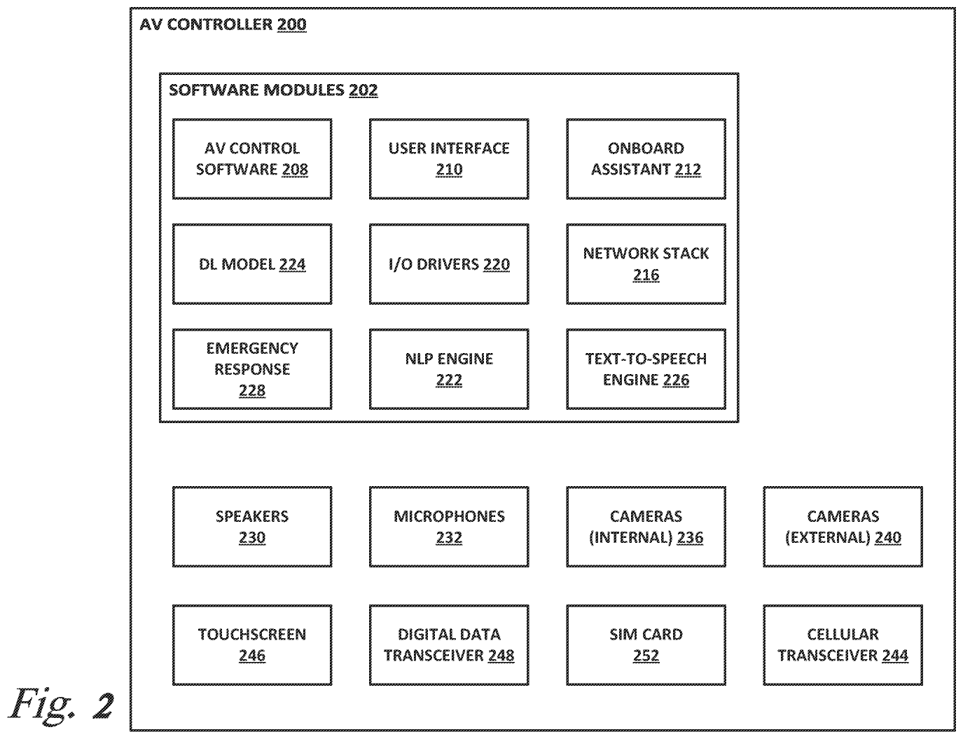

FIG. 2 is a block diagram of selected elements of an AV controller 200. Elements disclosed here are selected to illustrate operative principles of the present disclosure. Embodiments may include elements other than those disclosed here, and embodiments need not necessarily include all elements disclosed here.

AV controller 200 may be based on a hardware platform. The hardware platform may include a processor, memory, and other elements to provide the hardware infrastructure for AV controller 200. Examples of additional selected elements of a hardware platform are illustrated in FIG. 8 below.

AV controller 200 may include several peripheral devices that assist the AV controller in performing its function. These may include, by way of illustrative and non-limiting example, speakers 230, microphones 232, internal cameras 236. External cameras 240, touchscreen 246, digital data transceiver 248, subscriber identity module (SIM) card 252, and cellular transceiver 244.

Speakers 230 may be located internally and/or externally to the cabin of the vehicle and may be used to provide audible feedback to an occupant of the cabin of the cabin, or to people outside the vehicle. Microphones 232 may also be disposed within or without the vehicle and may be used to pick up audible cues from the environment. For example, microphones 232 may be used to detect speech, to monitor the environment, or to hear sounds such as sirens, horns, disturbances, or similar.

Internal cameras 236 may be used to monitor the interior of the vehicle, such as to monitor activity of occupants of the cabin of the vehicle. External cameras 240 may be used to monitor the external environment. External cameras 240 may be an integral part of the autonomous operation, which may rely in part on computer vision to identify visual elements of the external environment. Computer vision may enable the AV controller software to provide autonomous or semi-autonomous control of the vehicle. In embodiments, a camera may be used to identify contextual information, such as whether someone outside the car is attempting to block the car (such as in the context of a protest or threat).

Touchscreen 246 may provide an I/O interface for an occupant or passenger of the vehicle. Touchscreen 246 may be similar to a tablet, and may be a standalone device, or may be integrated into the AV as a fixture. In the same or a different embodiment, touchscreen 246 may be provided by a mobile device, laptop computer, or other device owned and provided by the passenger. Touchscreen 246 may provide a facility for the passenger to type messages, send texts, view maps, play games, communicate with the vehicle, communicate with rider support, or perform other actions that may be useful to the passenger or occupant.

Digital data transceiver 248, SIM card 252, and cellular transceiver 244 may form a communication suite. For example, digital data transceiver 248 may provide a network interface to a digital data service, such as a long-term evolution (LTE) fourth-generation (4G) service, a fifth-generation (5G) service, or some other similar wired or wireless digital data service. Digital data transceiver 248 may communicatively couple AV controller 200 to the internet or to other network services. SIM card 252 may operate with cellular transceiver 244 to provide voice communication via cellular communication networks. Sim card 252 provides a unique identity on the cellular network and may provide, for example, a phone number or other identifier for AV controller 200. Cellular transceiver 244 may include the hardware, software, and firmware elements to provide communication with a voice-based cellular communication network.

In embodiments, cellular transceiver 244 may be either a digital or an analog cellular network connection. In the case of a digital connection, cellular transceiver 244 may digitize voice communications and optionally compress data before sending the data over the cellular network.

AV controller 200 may also include a plurality of software modules 202. Software modules 202 may run on an operating system, such as an embedded or real-time operating system provided by AV controller 200. Software modules 202 provide various functions and facilities and may interact with appropriate hardware elements in performing their functions. The division of software elements within software modules 202 is provided as a logical division and is not necessarily representative of a physical division. In some cases, various software modules may run as dedicated services or microservices on AV controller 200 and may be isolated or sandboxed from one another. In other cases, some software modules may be bundled into a single physical or logical software module. Other configurations are possible.

AV control software 208 may include the primary logic for operating the AV. In the case that AV is fully autonomous (e.g., “L4” or higher, as defined by the society of automotive engineer (SAE)), AV control software 208 may have full control of the vehicle. In that case, a passenger or occupant of the vehicle may have no access to controls such as the accelerator or steering wheel. The system may be, for example, a ride-hail vehicle service, or a privately owned vehicle that is self-driving.

AV control software 208 receives data, for example, from speakers 230, cameras 236, 240, and other sensors as illustrated in FIG. 1. AV control software 208 may use AI, such as a deep learning (DL) model 224 to make control decisions for the AV. A single DL model 224 is illustrated in this figure, but in many embodiments multiple DL models are provided, and provide different functionality. In some cases, DL models 224 may be provided to enable not only the core AV control functionality, but to provide support functions such as those provided by onboard assistant 212.

AV controller 200 may also include a user interface 210. User interface 210 may be used, for example, to drive touchscreen 246, or to provide other interactions for a user, occupant, or passenger of the vehicle.

I/O drivers 220 may provide a software stack that enables communication between software modules 202 and various hardware elements such as those illustrated for AV controller 200.

A network stack 216 may be provided to communicatively couple AV controller 200 to an external network such as the internet, an intranet, or some other data communication network. Network stack 216 may communicate via digital data transceiver 248. Network stack 216 may also provide services for cellular transceiver 244.

AV controller 200 may include an onboard assistant 212. Onboard assistant 212 provides features that are useful to the passenger of the AV. Onboard assistant 212 may monitor for conditions that may trigger a session between the AV and a service agent. Onboard assistant 212 may be a client application that communicates with an AV operator to allow the passenger to interact with the service agent. The client application may establish a connection between the AV and the service agent when a session is triggered. The client application may transmit information such as sensor data or state of the user interface 210 from the AV controller 200, to the AV operator for facilitating the interaction with the service agent.

AV controller 200 may include an emergency response module 228. Emergency response module 228 may handle a special case or subset of the functions of onboard assistant 212. Emergency response module 228 may specifically be concerned with handling emergency conditions, such as a collision, mechanical failure, or other condition that poses a danger to the occupant or to the vehicle or both. Emergency response module 228 may be a client application that communicates with an AV operator or emergency services to handle such emergency conditions.

AV controller 200 may also include a natural language processing (NLP) engine 222, which may be used to understand verbal commands, queries, and other interactions with the passenger. For example, if the passenger speaks within the cabin of the AV, then microphones 232 may pick up the voice, and NLP engine 222 may use machine learning (such as DL model 224) to transcribe the spoken word. NLP engine 222 may also use a machine learning model to attempt to understand what the passenger has said and formulate a response.

Text-to-speech engine 226 may translate the response into human perceptible speech patterns, which may be driven to speakers 230. Text-to-speech provides real-time direct interaction between the passenger and the AV.

Exemplary System Involving a Fleet of AVs

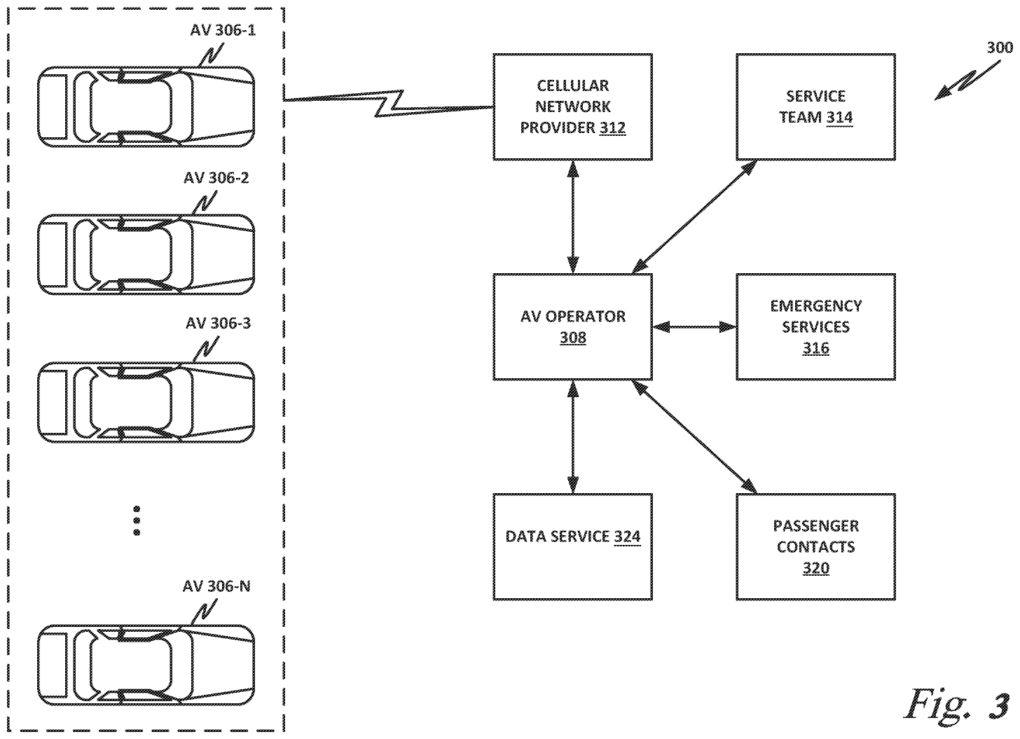

FIG. 3 is a block diagram illustration of selected elements of a system 300 involving a fleet of AVs. In this illustration, AV operator 308 may operate and include a fleet of AVs 306 and the infrastructure that manages and supports the fleet of AVs. Namely, illustrated here are AVs 306-1, 306-2, 306-3, through 306-N. AV operator 308 may include data centers, computer resources, electronic intelligence, and human operators including human service representatives or service agents. Human service representatives may have a user interface on which they may view AVs 306 within the fleet, including their GPS location, speed, destination, number of passengers, and other information. The user interface may be, for example, a graphical user interface (GUI), web interface, command-line interface (CLI), textual user interface (TUI), virtual reality (VR) interface, augmented reality (AR) interface, or other.

In some cases, and AV 306 (or rider of AV 306) may encounter an event or special condition that triggers a response by an onboard assistant, such as onboard assistant 212 of FIG. 2. Triggering events may include emergency or non-emergency events. For example, a triggering event that activates the onboard assistant may include a passenger pressing a hardware or software button, which initiates a call with the AV operator. In another example, a user asks a simple question which does not require further intervention from a service agent. In that case, the onboard assistant may autonomously answer the question and the interaction may stay local within the AV 306.

In cases where further intervention is required, AVs 306 may place a call or establish a communication session, e.g., via cellular network provider 312, to AV operator 308. Cellular network provider 312 may then provide a voice, video, or multi-media link between the AV 306, the passenger, and AV operator 308. In some cases, the call is initially placed as a conference call with the AV operator 308 in control of the conference call. The use of a conference call may enable AV operator 308 to manage the call, to add or remove parties as necessary, and to otherwise maintain contact with AV 306 and the passenger without interruption. In some cases, establishing the call as a conference call initially means that the passenger need not be placed on hold if AV operator 308 needs to involve other parties. For example, AV operator 308 may connect to a service team 314. The team could be an internal service team, or an outside service contractor. Service team 314 may help to resolve complaints, concerns, feedback (positive or negative), questions, or other service issues.

In some cases, a data service 324 may provide information to AV operator 308 and/or service team 314. For example, the passenger may book a ride with a ride-hail vehicle via a ride-hail application. The application may include a user account, wherein the rider opts to provide to provide and share certain information with AV operator 308. Information could include personally identifying information (PII) about the passenger, a phonebook of contacts, an emergency contact, user preferences, common routes and destinations, or similar. AV operator 308 may share information from data service 324 according to the terms of a license agreement, and according to a present need. For example, if service team 314 needs information from data service 324, then AV operator 308 may provide the information to service team 314.

In the case of an emergency, it may be desirable to provide other connections. For example, AV operator 308 may communicate with emergency services 316 to dispatch emergency crews to a current location of AV 306 to assess the situation and to provide aid to the passenger as necessary. AV operator 308 may cooperate with emergency response module 228 of FIG. 2 to provide information to emergency services 316 to facilitate dispatch of emergency crews or other emergency services. In some cases, data service 324 may include a list of known passenger contacts 320, or the passenger may use a mobile device such as a cell phone to share emergency contact with the onboard assistant. In the case of an emergency, AV operator 308 may contact an emergency contact on behalf of the passenger.

In other examples, the passenger may simply wish to place a call to one of his or her contacts, in which case AV operator 308 may connect the call and then, if appropriate, remove itself from the call so that there is a direct communication between the passenger and the passenger contact. In the same or a different embodiment, the onboard assistant may connect the passenger directly to a contact, without including AV operator 308.

As described above, the onboard assistant need not provide strictly emergency services. For example, data service 324 could also include a provider of games, movies, music, or other entertainment. AV operator 308 may stream entertainment content to an AV 306 via cellular network provider 312 or some other communication network.

In the same or a different embodiment, data service 324 may also provide useful information such as weather reports, traffic reports, breaking news, incident reports, or other. For example, the onboard assistant may use information from data service 324 to determine that adverse weather has made the planned route less desirable. As an illustration, the data service 324 may report a flash flood watch or flash flood warning, and the onboard assistant may determine that the planned route includes low water crossings. In that case, the onboard assistant may reroute to provide a better trip experience. The data service 324 may also provide information that could similarly be used to reroute to avoid construction, traffic, congestion, adverse conditions (e.g., civil unrest, a structural fire, a dangerous gas leak, etc.), or other conditions that affect the safety and/or desirability of the planned route.

AV operator 308 may also provide advice to the passenger in the event of other non-emergency situations that may nevertheless be stressful or uncomfortable. For example, if a police officer pulls over the ride-hail vehicle, AV operator 308 may establish a call with an AV 306 via the onboard assistant, and help the passenger to remain calm, answer questions for the passenger, or assist the passenger in interacting with the law enforcement official.

Other illustrative functions of an onboard assistant may be seen throughout this specification.

Exemplary Method of Providing Onboard Assistance to a Passenger of an AV

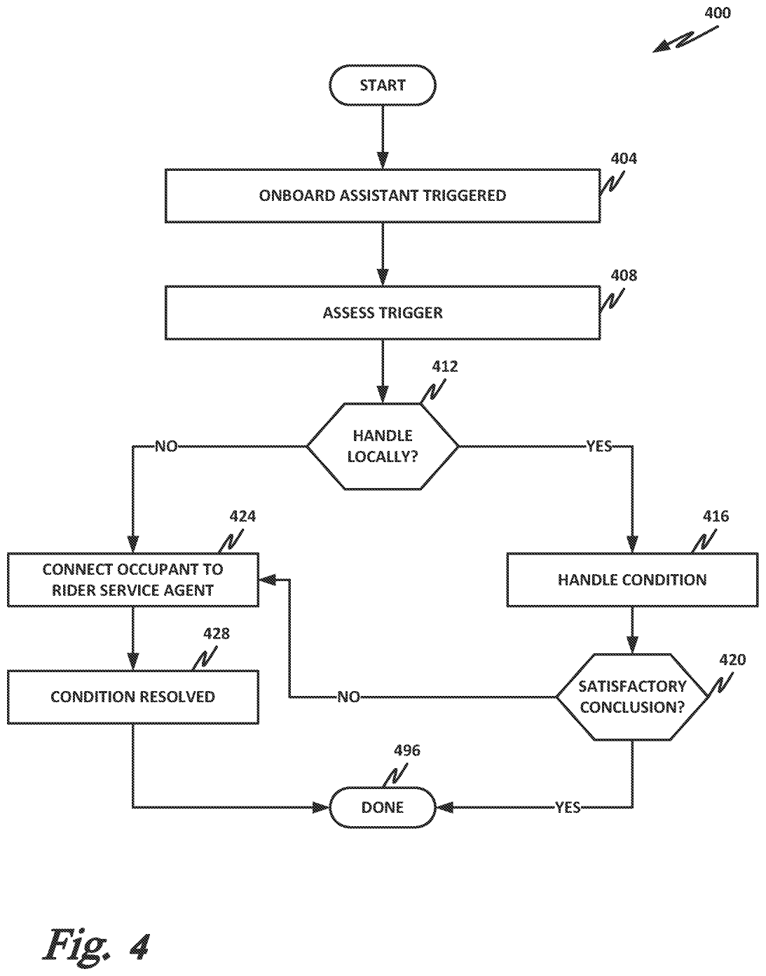

FIG. 4 is a flowchart of method 400 of providing onboard assistance to a passenger of an AV.

In block 404, an appropriate event, often referred to herein as a service incident, triggers the onboard assistant (e.g., onboard assistant 212 of FIG. 2). As discussed above, this could be an emergency or non-emergency event. For example, this may include a button push by the passenger, an accident, a law enforcement interaction, hazardous weather, civil unrest, a hazard, a service complaint, problematic behavior by the passenger, or other event.

In block 408, the onboard assistant may assess the trigger to determine the appropriate response. In particular, the onboard assistant may determine whether the incident is to be handled locally (e.g., by the AV controller 200 and/or onboard assistant 212 of FIG. 2) or remotely (e.g., by the AV operator 308 and/or service team 314 of FIG. 3). In some cases, although not illustrated in FIG. 4, an incident can be handled locally and remotely in combination.

In decision block 412, the onboard assistant decides whether to handle the interaction locally, according to the assessment of block 408. If the interaction is to be handled locally, then in block 416, the AV controller handles the interaction, which may include, for example, handling a user request to stream entertainment services, answering questions from the user, determining that the user has asked to be let out of the AV early, or performing some other function that the AV controller may handle on its own without outside intervention.

In decision block 420, the AV controller determines whether there was a satisfactory conclusion to the onboard assistance trigger, or whether additional action is necessary. If the interaction was successfully handled, then in block 496 the method is done.

Returning to decision block 420, if there was not a satisfactory conclusion, and if it is necessary to involve an outside agent, then control may pass to block 424.

Returning to decision block 412, if the interaction cannot be handled locally, then control passes to block 424. Within block 424, either because the AV controller initially decided not to handle the interaction locally, or because the AV controller was unable to satisfactorily conclude the interaction, the AV controller may communicatively couple to the AV operator, for example, to rider service or rider service. Connecting to rider service may enable the occupant to talk with a human rider support agent, or to interact with a device that has more capability than the onboard AV controller. Such a device may include a service agent, or some other agent of the AV operator. In some cases, this may also include connecting to emergency services or other third parties, to ensure that the user receives timely assistance in the event of an emergency or non-emergency condition.

In block 428, the condition is resolved with the intervention of appropriate human or other actors.

In block 496, the method is done.

Exemplary System Implementing Remote Cabin Controls

When providing assistance to a passenger, the onboard assistant or a service agent with the AV operator may transmit commands to execute a remote cabin control command to resolve an issue, or to improve the experience of the passenger in the vehicle. Allowing remote cabin control commands for the AV is not trivial, because commands for controlling the cabin systems or adjusting the settings of the cabin may conflict with each other from different sources, commands may conflict with a state of the mechanical systems on the AV (e.g., an invalid command, or a command cannot be executed), or commands may cause undesirable behavior or results if the commands not managed or controlled appropriately.

Some regulation may be implemented to address or alleviate some of these concerns. In some cases, a form of arbitration may be implemented to resolve conflicts between commands that originate from different sources, such as hardware controls, software controls provided on a user interface, and a remote system or a service agent. In some cases, commands may be prioritized, queued, or placed in a certain order. In some cases, one conflicting command may override another command. In some cases, one command may supplement or augment another command. In some cases, commands may be filtered where selected commands are ignored or rejected. In some cases, commands may be rejected. In some cases, previously executed commands may be undone. In some cases, commands may be modified before they are executed.

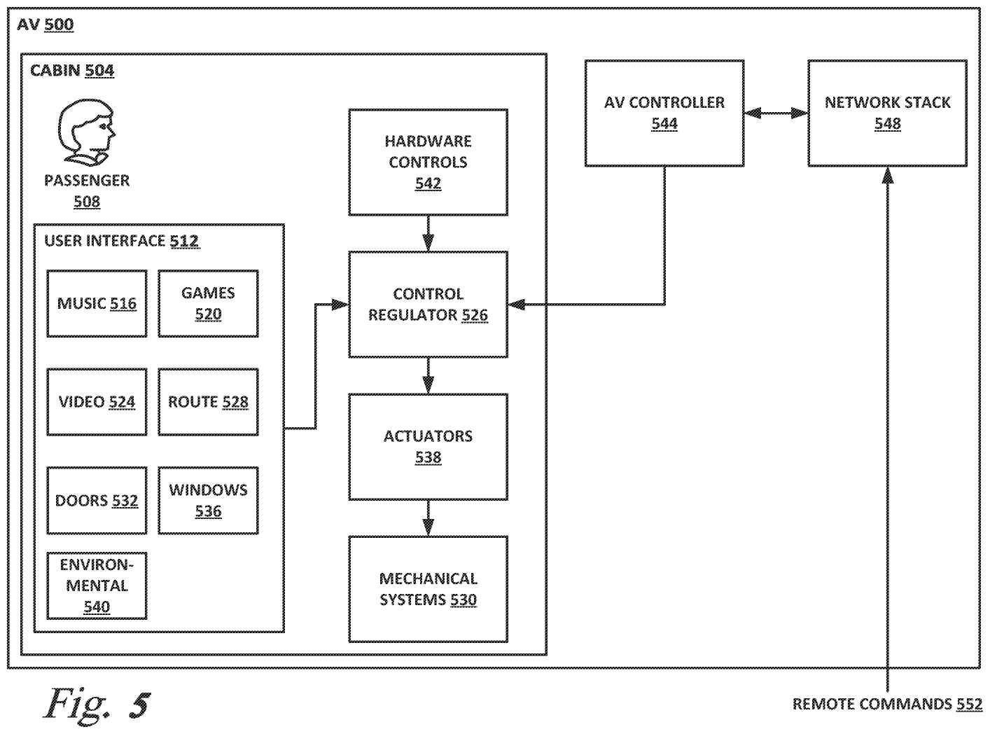

FIG. 5 is a block diagram of selected elements of an AV 500. Elements illustrated here are to aid in understanding aspects of the present specification. Control regulator 526 is provided to provide some regulation on the commands that may originate from different sources (e.g., the user interface 512, hardware controls 542, and a service agent sending remote commands 552).

AV 500 is controlled by an AV controller 544, which has access to a network stack 548. AV controller 544 may be based on a hardware platform, as illustrated throughout the specification, and network stack 548 may provide the hardware and software elements to provide wireless communication to AV controller 544.

Within AV 500 is a cabin 504. Cabin 504 may be configured to carry a human passenger 508 (though the cabin 504 can carry more than one passenger, cargo, and/or animals). Cabin 504 may include the passenger compartment, a cargo compartment, or others. The cabin may include a number of cabin controls that may be manipulated by a passenger or that may be manipulated remotely.

User interface 512 may provide access to various features shown in FIG. 5 by way of illustrative and non-limiting example. Features may include a music service 516, games 520, and video 524. A route display 528 may provide a real-time or near real-time GPS display of the customer's present route and destination. Route display 528 may also provide passenger 508 the ability to select a new route. For example, passenger 508 may book AV 500 via a ride-hail vehicle ride-hail or ride-share app and may put in a desired destination for the initial trip. However, during the trip, passenger 508 may encounter a condition, whether an emergency condition or non-emergency condition, that makes it necessary or desirable for passenger 508 to select a new destination. In that case, route display 528 may provide passenger 508 with the ability to select a new destination. In that case, route display 528 may inform passenger 508 of whether it is possible or practical for AV 500 to adopt the new route and may also inform passenger 508 of any changes to the cost of the trip based on the new route.

The user interface 512 may be provided by a touch screen tablet that the human passenger may operate during the ride. Alternatively, an application installed on the user's mobile device may operate as the user interface 512 during the trip. The user interface 512 may include speakers, microphones, and cameras, and/or monitors provided within the AV 500. The user interface 512 may provide entertainment options, such as music, video, games, trip information, GPS displays, and others. User interface 512 may also provide a software-implemented button (e.g., a user interface element displayed on a touch screen) to engage the onboard assistant, such as by placing a call to a rider service agent. In some cases, new passengers may wish to operate the onboard assistant simply to reassure himself or herself that there is a human being on the other end. In some cases, the user interface 512 may provide the passenger with a full audio-video conference call with a rider service agent or other agent of the AV operator, or with the user's own contacts, with emergency services personnel, or others.

The human passenger may have access to various controls, including through a user interface 512 and/or through hardware controls 542.

Hardware controls 542 may manipulate certain mechanical systems 530 to adjust certain cabin controls and/or settings within the AV. Hardware controls 542 can correspond to physical buttons, switches, knobs, sensor, turn dials, pedal, or handles, provided in the cabin, that passenger 508 can physically actuate. The hardware controls 542, when actuated by passenger 508, may direct mechanical systems 530 to perform functions such as: changing the cabin temperature (directing the heating and cooling system), locking or unlocking a door, opening or closing a window, turning seat heater or cooler on or off, turning seat massager on or off, honking a horn, closing or opening an air vent, changing the radio selection, changing volume of the infotainment system, or any other appropriate control of the cabin mechanical systems. Other exemplary functions may include: control of doors, control of windows, honking a horn, control of air conditioner, control of heating, control of glass defrost, control of audio (including volume), control of video, control of radio, or others.

In some cases, passenger 508 may operate user interface 512 to electronically control certain aspects of the cabin 504 (such as ones illustrated herein) in addition to or in lieu of hardware controls 542. For instance, passenger 508 may, though the user interface 512, send doors control commands 532, windows control commands 536, and/or environmental controls commands 540. Environmental controls commands 540 may include commands for controlling and/or adjusting air conditioning, heat, defrost, dehumidifier, or other available controls. Passenger 508 may also operate user interface 512 to control settings of the infotainment system.

In addition to cabin controls provided directly by passenger 508 via user interface 512 and/or hardware controls 542, AV controller 544 may receive remote commands 552 from the AV operator (e.g., a service agent) via a network stack 548. For example, remote commands 552 may be received from an operations center for the AV operator. AV controller 544 may then provide the remote commands 552 to control regulator 526.

Control regulator 526 receives input commands from various sources, such as from user interface 512, hardware controls 542, and AV controller 544. Control regulator 526 may be included to select which input commands to prefer or prioritize particularly in the case of competing input commands. For example, if passenger 508 and the operations center via remote commands 552 both request an environmental controls command, control regulator 526 may determine which one has precedence. This determination may include always allowing override from remote commands 552, always allowing override from passenger 508, always allowing override from hardware controls 542, or moderating access based on conditions such as external social, weather, temperature, or other conditions.

In some cases, control regular 526 may receive inputs such as state information of the mechanical systems 530, state information of the AV 500, state information of the user interface 512, and state information of the passenger 508. These inputs may facilitate resolution of conflicting commands, and/or determination of whether a command is invalid.

Control regulator 526 may select a preferred input command from the various sources and may drive an output to actuators 538. Actuators 538 then manipulate mechanical systems 530 to carry out the desired input. Actuators 538 may electronically operate the cabin controls either in response to local passenger inputs or in response to remote inputs.

Exemplary System Implementing Remote Cabin Controls

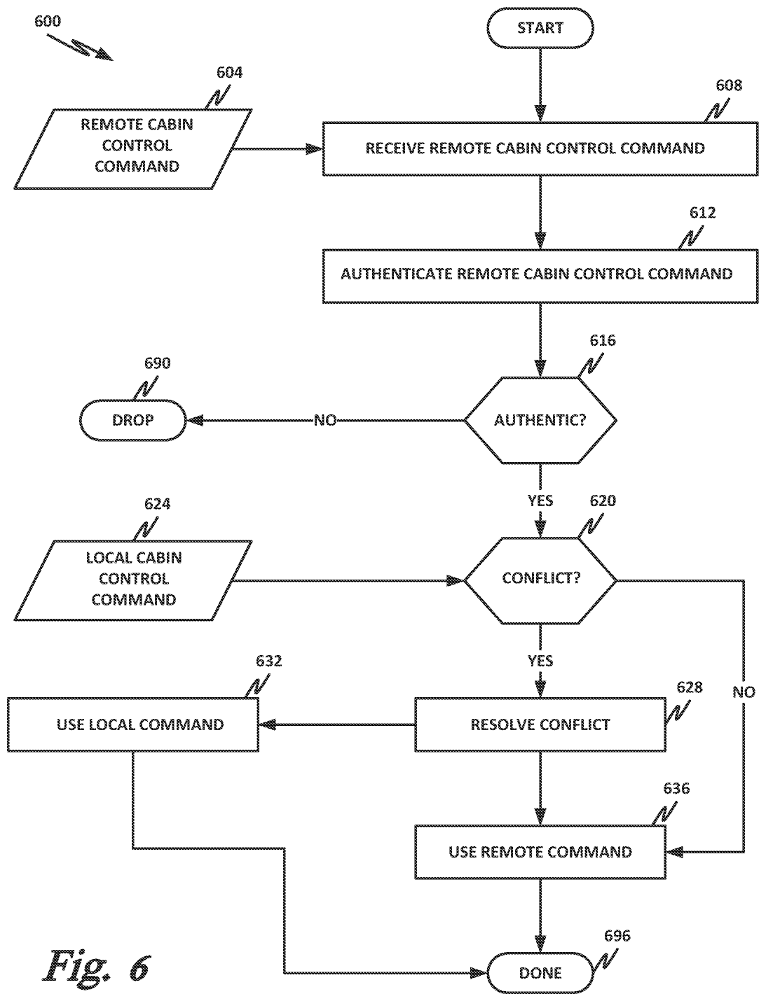

FIG. 6 is a flowchart of a method 600 of providing remote access to cabin controls. Method 600 can be implemented by various components illustrated in FIG. 5. The following description illustrates various exemplary functionalities of the control regulator 526.

In block 608, the AV controller receives a remote cabin control command 604. Remote cabin control command 604 may be received, for example, from AV operator, a rider service center, an operations center, or similar. In some cases, remote cabin control command 604 are sent in response to opening of a rider service request or to resolve a rider service instance. The rider service request may be initiated by a passenger of an AV. The rider service may be initiated in response to sensor data collected by the AV (e.g., a collision, or a medical event detected by the AV). For instance, a rider service request may be initiated, and the AV controller receive a remote cabin control command as a response to a rider service request. In one example, if a passenger indicates that the cabin is too hot, too cold, or have some other problem, the remote cabin control command can be sent to address or resolve the passenger's concern.

In block 612, the AV controller attempts to authenticate the remote cabin control command 604. Authenticating in the remote cabin control command may comprise using a networked authentication protocol. Authentication of the remote cabin control command confirms whether the command originated from a trusted source, such as a trusted AV operator.

In decision block 616, the AV controller determines whether the remote cabin control commands are authentic. If the remote cabin control commands are not found to be authentic, then in block 690, the AV controller drops or rejects the inauthentic command and the method is done.

Returning to decision block 616, if the remote cabin control commands are authentic, then in block 620, the AV controller, e.g., control regulator 526 of FIG. 5, can perform one or more regulation functions.

For instance, the AV controller can check whether there are conflicting local control commands received from local cabin control command 624 (e.g., from passenger 508 through user interface 512 and/or hardware controls 542). The remote cabin control command 604 is checked to see if the remote command conflicts with local control commands. If there are no conflicting local commands, then in block 636, the AV controller uses the remote command.

Returning to decision block 620, if there are conflicting control commands, then in block 628, the AV controller resolves the conflict. Resolving the conflict may include operating an algorithm or rule that prefers local and/or remote input. The algorithm may always prefer local input, always prefer remote input, or conditionally prefer one or the other according to a set of conditions or priorities. For example, the user-operable cabin controls (i.e., control commands made by the passenger through user interface 512 and/or hardware controls 542) may override remote cabin control commands in appropriate circumstances. In another example, remote cabin control commands may override user cabin control commands in appropriate circumstances (e.g., while a rider service request is being serviced). In response to resolving the conflict, then one of two things may happen. In block 632, the system may use the local control as the preferred input. Alternatively, in block 636, the system may use the remote command as the preferred input. In either case, the preferred command is carried out, and in block 696, the method is done.

Block 620 may perform other exemplary regulation functions besides conflict checking. The following passages illustrate some additional examples.

In various embodiments, selecting a preferred command in view of conflicting commands may include accounting for instant conditions. For example, a driving mode may be considered as an instant condition. Driving modes may include full-autonomous, semi-autonomous, or full manual operation. The passenger may be given greater control over cabin controls in semi-autonomous or manual operation than in full-autonomous operation. In other words, the local cabin control command 624 may override the remote cabin control command 604 when the AV is in semi-autonomous or manual operation.

In some cases, the decision for selecting a preferred command in view of conflicting commands may account for ownership of the vehicle. For example, if the AV is a personal AV, the occupant may have greater autonomy over the cabin controls than in the case of a ride-hail, ride-share, or autonomous taxi service, where certain cabin control commands may be limited or selectively overridden to preserve the integrity or operability of the vehicle.

In some cases, air conditioning could be overridden by the AV controller, or remotely by an AV operator based on the location of the AV and/or the weather conditions surrounding the AV. By way of example, if the vehicle is operating in a very hot region such as the Mojave Desert of Eastern California, operating the air conditioner at a very cold temperature could pose a danger of engine. Thus, an occupant control of the air conditioner could be limited, depending on the location of and/or weather conditions surrounding the AV.

In some cases, passengers may also have the option to control interior or exterior lights. In some cases, remote cabin control commands may override local passenger control of the lights, such as for safety and/or legal compliance. In some cases, local passenger control of interior lights may be overridden by a remote cabin control command if suspicious activity or other concerning activity has been detected in the cabin. In some cases, local passenger control of exterior lights may be overridden by a remote cabin control command during night time where legal regulations may require certain exterior lighting. In some cases, local passenger control of exterior lights may be overridden by a remote cabin control command during inclement weather where legal regulations may require certain exterior lighting. In some cases, local passenger control of exterior lights may be overridden by a remote cabin control command during an emergency situation, where interior and/or exterior lights are being used to alert emergency personnel.

In some cases, local cabin control commands may be supplemented or overridden to provide support to a passenger of the vehicle or to the vehicle. If a passenger expressed discomfort due to motion sickness, but local cabin control commands only opened a subset of the windows, a remote cabin control command may be supplement the local control commands by opening all the windows of the vehicle. If the AV senses that cabin was overheating and local cabin control commands had instructed the heater to be at the maximum level, a remote cabin control command may override the local cabin control command to turn the heater down or off.

In some cases, local cabin control commands may be supplemented or overridden based on data from sensors of the AV or data from other external sources, such as for weather conditions, traffic conditions, social conditions, or other. For instance, local cabin control commands to open windows may be overridden by a remote cabin control command to close the windows during a storm, near a traffic accident, or during a traffic jam.

In some cases, local and/or remote cabin control commands may be rejected based on data from sensors on the AV, or external data, such as weather conditions, traffic conditions, social conditions, or other. For instance, cabin control commands may be rejected if it is determined that data from sensors or external data violates a rule.

In some cases, remote cabin control commands may conditionally override the user-operable cabin controls according to an override condition, e.g., external weather, temperature, or social condition.

In some cases, some control commands may be mutually exclusive, and the control regulator may drop a command if the command cannot occur when another command is present or is being executed. For example, a call module may be capable of making only one call at a time. Thus, other calls may be overridden, ignored, or dropped for the duration of the call. If an incoming or outgoing call is of sufficient priority (e.g., an emergency condition or accident), the new call may override the existing call, which may be terminated.

In some cases, control commands from various sources (e.g., control commands from the passenger and/or remote control commands from the operator) may be queued, for example according to a temporal sequence, as in the order the commands were received. In another example, the control commands may be queued based on a pre-determined priority ranking of the sources from which the commands originate.

In some cases, cabin control commands may be adjusted or limited according to other factors, such as general legal and safety compliance. For example, if the passenger turns the volume up too loud in an area with a noise ordinance, the passenger's control of the volume may be modified, overridden, or undone to comply with the ordinance.

In some cases, some cabin control commands may be modified according to instant conditions surrounding the AV (e.g., presence of danger or a threat). For example, if external data sources and/or AV sensor data indicate that the AV is traveling through a region where a large protest is taking place, especially if protesters are blocking traffic or harassing drivers, remote cabin control commands may instruct the AV to roll up windows, lock doors, or take other safety precautions. In some cases, the doors may be one-way locked, for example to prevent others from entering the vehicle, but not prevent the passenger from exiting the vehicle.

In some cases, some cabin control commands may be rejected based on the state of the cabin controls or the mechanical systems of the AV. In some cases, the state of the mechanical systems of the AV limits what control commands can be executed. For instance, if the windows are already closed, a remote cabin control command to close the windows may be rejected since the command would be invalid.

Exemplary Hardware Platform

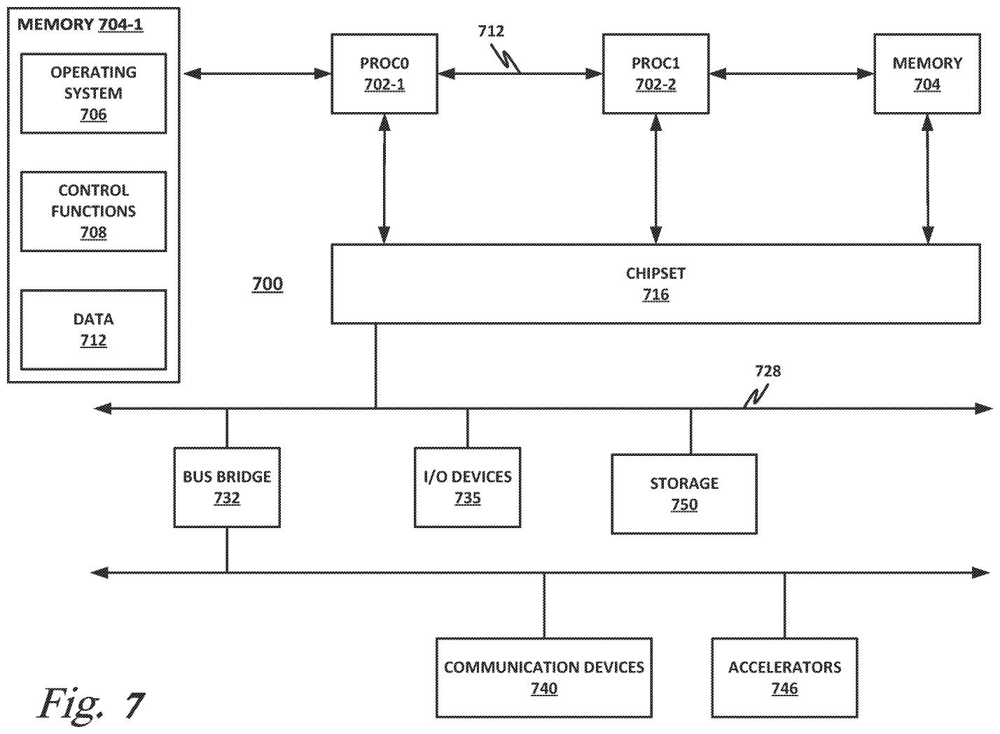

FIG. 7 is a block diagram of a hardware platform 700. Although a particular configuration is illustrated here, there are many different configurations of hardware platforms, and this embodiment is intended to represent the class of hardware platforms that may provide a computing device. Furthermore, the designation of this embodiment as a “hardware platform” is not intended to require that all embodiments provide all elements in hardware. Some of the elements disclosed herein may be provided, in various embodiments, as hardware, software, firmware, microcode, microcode instructions, hardware instructions, hardware or software accelerators, or similar. Hardware platform 700 may provide a suitable structure for controller 104 of FIG. 1, for AV controller 200 of FIG. 2, for carrying out the functionalities and implementing systems illustrated in FIGS. 5-6, as well as for other computing elements illustrated throughout this specification, including elements external to AV 102. Depending on the embodiment, elements of hardware platform 700 may be omitted, and other elements may be included.

Hardware platform 700 is configured to provide a computing device. In various embodiments, a “computing device” may be or comprise, by way of non-limiting example, a computer, system-on-a-chip (SoC), workstation, server, mainframe, virtual machine (whether emulated or on a “bare metal” hypervisor), network appliance, container, a data center, a communications service provider infrastructure, an in-memory computing environment, a computing system of a vehicle (e.g., an automobile or airplane), embedded computer, embedded controller, embedded sensor, smart phone, tablet computer, wearable computer, or any other electronic device for processing and communicating data. At least some of the methods and systems disclosed in this specification may be embodied by or carried out on a computing device.

In the illustrated example, hardware platform 700 is arranged in a point-to-point (PtP) configuration. This PtP configuration is popular for personal computer (PC) and server-type devices, although it is not so limited, and any other bus type may be used. The PtP configuration may be an internal device bus that is separate from CAN bus 170 of FIG. 1, although in some embodiments they may interconnect with one another.

Hardware platform 700 is an example of a platform that may be used to implement embodiments of the teachings of this specification. For example, instructions could be stored in storage 750. Instructions could also be transmitted to the hardware platform in an ethereal form, such as via a network interface, or retrieved from another source via any suitable interconnect. Once received (from any source), the instructions may be loaded into memory 704, and may then be executed by one or more processor 702 to provide elements such as an operating system (OS) 706, control functions 708, or data 712.

Hardware platform 700 may include several processors 702. For simplicity and clarity, only processors PROC0 702-1 and PROC1 702-2 are shown. Additional processors (such as 2, 4, 8, 16, 24, 32, 64, or 128 processors) may be provided as necessary, while in other embodiments, only one processor may be provided. Processors 702 may be any type of processor and may communicatively couple to chipset 716 via, for example, PtP interfaces. Chipset 716 may also exchange data with other elements. In alternative embodiments, any or all of the PtP links illustrated in FIG. 7 could be implemented as any type of bus, or other configuration rather than a PtP link. In various embodiments, chipset 716 may reside on the same die or package as a processor 702 or on one or more different dies or packages. Each chipset may support any suitable number of processors 702. A chipset 716 (which may be a chipset, uncore, Northbridge, Southbridge, or other suitable logic and circuitry) may also include one or more controllers to couple other components to one or more central processor units (CPU).

Two memories, 704-1 and 704-2 are shown, connected to PROC0 702-1 and PROC1 702-2, respectively. As an example, each processor is shown connected to its memory in a direct memory access (DMA) configuration, though other memory architectures are possible, including ones in which memory 704 communicates with a processor 702 via a bus. Memory 704 may include any form of volatile or nonvolatile memory. Memory 704 may be used for short, medium, and/or long-term storage. Memory 704 may store any suitable data or information utilized by platform logic. In some embodiments, memory 704 may also comprise storage for instructions that may be executed by the cores of processors 702 or other processing elements (e.g., logic resident on chipsets 716) to provide functionality. In certain embodiments, memory 704 may comprise a relatively low-latency volatile main memory, while storage 750 may comprise a relatively higher-latency nonvolatile memory. However, memory 704 and storage 750 need not be physically separate devices, and in some examples may simply represent a logical separation of function (if there is any separation at all).

Certain computing devices provide main memory 704 and storage 750, for example, in a single physical memory device, and in other cases, memory 704 and/or storage 750 are functionally distributed across many physical devices. In the case of virtual machines or hypervisors, all or part of a function may be provided in the form of software or firmware running over a virtualization layer to provide the logical function, and resources such as memory, storage, and accelerators may be disaggregated (i.e., located in different physical locations across a data center). In other examples, a device such as a network interface may provide only the minimum hardware interfaces necessary to perform its logical operation and may rely on a software driver to provide additional necessary logic. Thus, each logical block disclosed herein is broadly intended to include one or more logic elements configured and operable for providing the disclosed logical operation of that block. As used throughout this specification, “logic elements” may include hardware, external hardware (digital, analog, or mixed-signal), software, reciprocating software, services, drivers, interfaces, components, modules, algorithms, sensors, components, firmware, hardware instructions, microcode, programmable logic, or objects that may coordinate to achieve a logical operation.

Chipset 716 may be in communication with a bus 728 via an interface circuit. Bus 728 may have one or more devices that communicate over it, such as a bus bridge 732, I/O devices 735, accelerators 746, and communication devices 740, by way of non-limiting example. In general terms, the elements of hardware platform 700 may be coupled together in any suitable manner. For example, a bus may couple any of the components together.

Communication devices 740 may broadly include any communication not covered by a network interface and the various I/O devices described herein. Devices may include, serial or parallel devices that provide communications. In a particular example, communication device 740 may be used to stream and/or receive data within a CAN.

I/O devices 735 may be configured to interface with any auxiliary device that connects to hardware platform 700 but that is not necessarily a part of the core architecture of hardware platform 700. A peripheral may be operable to provide extended functionality to hardware platform 700 and may or may not be wholly dependent on hardware platform 700. Peripherals may include input and output devices such as displays, terminals, printers, keyboards, mice, modems, data ports, network controllers, optical media, external storage, sensors, transducers, actuators, controllers, data acquisition buses, cameras, microphones, speakers, or external storage, by way of non-limiting example.

Bus bridge 732 may be in communication with other devices such as a keyboard/mouse 738 (or other input devices such as a touch screen, trackball, etc.), communication devices 740 (such as modems, network interface devices, peripheral interfaces such as PCI or PCIe, or other types of communication devices that may communicate through a network), and/or accelerators 746. In alternative embodiments, any portions of the bus architectures could be implemented with one or more PtP links.

OS 706 may be an embedded or real-time operating system. In some embodiments, a hardware platform 700 may function as a host platform for one or more guest systems that invoke application (e.g., control functions 708).

Control functions 708 may include one or more computing engines that may include one or more non-transitory computer-readable mediums having stored thereon executable instructions operable to instruct a processor to provide operational functions. At an appropriate time, such as upon booting hardware platform 700 or upon a command from OS 706 or a user or security administrator, a processor 702 may retrieve a copy of the operational agent (or software portions thereof) from storage 750 and load it into memory 704. Processor 702 may then iteratively execute the instructions of control functions 708 to provide the desired methods or functions.

There are described throughout this specification various engines, modules, agents, servers, applications, or functions. Each of these may include any combination of one or more logic elements of similar or dissimilar species, operable for and configured to perform one or more methods provided by the engine. In some cases, the engine may be or include a special integrated circuit designed to carry out a method or a part thereof, a field-programmable gate array (FPGA) programmed to provide a function, a special hardware or microcode instruction, other programmable logic, and/or software instructions operable to instruct a processor to perform the method. The engine may also include other hardware, software, and/or data, including configuration files, registry entries, application programming interfaces (APIs), and interactive or user-mode software by way of non-limiting example.

In some cases, the function of an engine is described in terms of a “circuit” or “circuitry to” perform a particular function. The terms “circuit” and “circuitry” should be understood to include both the physical circuit, and in the case of a programmable circuit, any instructions or data used to program or configure the circuit.

Where elements of an engine are embodied in software, computer program instructions may be implemented in programming languages, such as an object code, an assembly language, or a high-level language. These may be used with any compatible operating systems or operating environments. Hardware elements may be designed manually, or with a hardware description language. The source code may define and use various data structures and communication messages. The source code may be in a computer executable form (e.g., via an interpreter), or the source code may be converted (e.g., via a translator, assembler, or compiler) into a computer executable form, or converted to an intermediate form such as byte code. Where appropriate, any of the foregoing may be used to build or describe appropriate discrete or integrated circuits, whether sequential, combinatorial, state machines, or otherwise.

Communication devices 740 may communicatively couple hardware platform 700 to a wired or wireless network or fabric. A “network,” as used throughout this specification, may include any communicative platform operable to exchange data or information within or between computing devices. A network interface may include one or more physical ports that may couple to a cable (e.g., an Ethernet cable, other cable, or waveguide), or a wireless transceiver.

In some cases, some or all of the components of hardware platform 700 may be virtualized, in particular the processor(s) and memory. For example, a virtualized environment may run on OS 706, or OS 706 could be replaced with a hypervisor or virtual machine manager. In this configuration, a virtual machine running on hardware platform 700 may virtualize workloads. A virtual machine in this configuration may perform essentially all the functions of a physical hardware platform.

In a general sense, any suitably configured processor may execute any type of instructions associated with the data to achieve the operations illustrated in this specification. Any of the processors or cores disclosed herein could transform an element or an article (for example, data) from one state or thing to another state or thing. In another example, some activities outlined herein may be implemented with fixed logic or programmable logic (for example, software and/or computer instructions executed by a processor).

Various components of the system depicted in FIG. 7 may be combined in a SoC architecture or in any other suitable configuration. For example, embodiments disclosed herein may be incorporated into systems including mobile devices such as smart cellular telephones, tablet computers, personal digital assistants, portable gaming devices, and similar. These mobile devices may be provided with SoC architectures in at least some embodiments. Such an SoC (and any other hardware platform disclosed herein) may include analog, digital, and/or mixed-signal, radio frequency (RF), or similar processing elements. Other embodiments may include a multichip module (MCM), with a plurality of chips located within a single electronic package and configured to interact closely with each other through the electronic package. In various other embodiments, the computing functionalities disclosed herein may be implemented in one or more silicon cores in application-specific integrated circuits (ASICs), FPGAs, and other semiconductor chips.

Variations and Implementations

As will be appreciated by one skilled in the art, aspects of the present disclosure, described herein, may be embodied in various manners (e.g., as a method, a system, a computer program product, or a computer-readable storage medium). Accordingly, aspects of the present disclosure may take the form of an entirely hardware embodiment, an entirely software embodiment (including firmware, resident software, microcode, etc.) or an embodiment combining software and hardware aspects that may all generally be referred to herein as a circuit, module, or system. In at least some cases, a circuit may include the physical hardware of the circuit, plus any hardware or firmware that programs or configures the circuit. For example, a network circuit may include the physical network interface circuitry, as well as the logic (software and firmware) that provides the functions of a network stack.

Functions described in this disclosure may be implemented as an algorithm executed by one or more hardware processing units, e.g., one or more microprocessors, of one or more computers. In various embodiments, different steps and portions of the steps of each of the methods described herein may be performed by different processing units. Furthermore, aspects of the present disclosure may take the form of a computer program product embodied in one or more computer-readable medium(s), preferably non-transitory, having computer-readable program code embodied, e.g., stored, thereon. In various embodiments, such a computer program may, for example, be downloaded (updated) to the existing devices and systems (e.g., to the existing perception system devices and/or their controllers, etc.) or be stored upon manufacturing of these devices and systems.

The foregoing detailed description presents various descriptions of specific certain embodiments. However, the innovations described herein may be embodied in a multitude of different ways, for example, as defined and covered by the claims and/or select examples. In the following description, reference is made to the drawings where like reference numerals may indicate identical or functionally similar elements. It will be understood that elements illustrated in the drawings are not necessarily drawn to scale. Moreover, it will be understood that certain embodiments may include more elements than illustrated in a drawing and/or a subset of the elements illustrated in a drawing. Further, some embodiments may incorporate any suitable combination of features from two or more drawings.

The preceding disclosure describes various illustrative embodiments and examples for implementing the features and functionality of the present disclosure. While components, arrangements, and/or features are described below in connection with various example embodiments, these are merely examples used to simplify the present disclosure and are not intended to be limiting.

In the specification, reference may be made to the spatial relationships between various components and to the spatial orientation of various aspects of components as depicted in the attached drawings. However, as will be recognized by those skilled in the art after a complete reading of the present disclosure, the devices, components, members, apparatuses, etc. described herein may be positioned in any desired orientation. Thus, the use of terms such as “above,” “below,” “upper,” “lower,” “top,” “bottom,” or other similar terms to describe a spatial relationship between various components or to describe the spatial orientation of aspects of such components, should be understood to describe a relative relationship between the components or a spatial orientation of aspects of such components, respectively, as the components described herein may be oriented in any desired direction. When used to describe a range of dimensions or other characteristics (e.g., time, pressure, temperature, length, width, etc.) of an element, operations, and/or conditions, the phrase “between X and Y” represents a range that includes X and Y.

Other features and advantages of the disclosure will be apparent from the description and the claims. Note that all optional features of the apparatus described above may also be implemented with respect to the method or process described herein and specifics in the examples may be used anywhere in one or more embodiments.

The “means for” in these instances (above) may include (but is not limited to) using any suitable component discussed herein, along with any suitable software, circuitry, hub, computer code, logic, algorithms, hardware, controller, interface, link, bus, communication pathway, etc. In a second example, the system includes memory that further comprises machine-readable instructions that when executed cause the system to perform any of the activities discussed above.

It should be noted that throughout the FIGURES, certain reference numerals may be repeated to indicate that a particular device or block is referenced multiple times across several FIGURES. In other cases, similar elements may be given new numbers in different FIGURES. Neither of these practices is intended to require a particular relationship between the various embodiments disclosed. In certain examples, a genus or class of elements may be referred to by a reference numeral (“widget 10”), while individual species or examples of the element may be referred to by a hyphenated numeral (“first specific widget 10-1” and “second specific widget 10-2”).

As described herein, one aspect of the present technology is the gathering and use of data available from various sources to improve quality and experience. The present disclosure contemplates that in some instances, this gathered data may include personal information. The present disclosure contemplates that the entities involved with such personal information respect and value privacy policies and practices.

What is claimed is:

1. An autonomous vehicle, comprising:
a vehicle chassis comprising a drive system and a cabin comprising a plurality of cabin controls;
an autonomous vehicle controller, comprising a processor circuit and a memory, wherein the memory includes instructions to instruct the processor circuit to operate the drive system autonomously;
actuators to electronically operate the cabin controls;
a communication circuit with wireless communication capability; and
instructions encoded within the memory to further instruct the processor circuit to:
receive a remote cabin control command via the communication circuit; and
receive a local cabin control command from a passenger of the autonomous vehicle via a user interface and/or hardware controls;
perform control regulation of the remote cabin control command and the local cabin control command; and
cause the actuators to perform an action in response to a result of the control regulation.

2. The autonomous vehicle of claim 1, wherein the instructions are further to authenticate the remote cabin control command.

3. The autonomous vehicle of claim 1, wherein the instructions are further to drop the remote cabin control command if the remote cabin control command is found to be inauthentic.

4. The autonomous vehicle of claim 1, wherein the instructions are further to:
cause a rider service request to be transmitted to an autonomous vehicle operator; and
receive the remote cabin control command as a response to the rider service request.

5. The autonomous vehicle of claim 1, wherein performing control regulation comprises:
allowing the local cabin control command to override the remote cabin control command.

6. The autonomous vehicle of claim 1, wherein performing control regulation comprises:
allowing the remote cabin control command to override the local cabin control command.

7. The autonomous vehicle of claim 1, wherein performing control regulation comprises:
allowing the remote cabin control command to override the local cabin control command if the remote cabin control command is sent in response to a rider service request.

8. The autonomous vehicle of claim 1, wherein the remote cabin control command is to conditionally override local cabin control command based on an override condition.

9. The autonomous vehicle of claim 8, wherein the override condition comprises external weather, temperature, or social condition.

10. The autonomous vehicle of claim 1, wherein performing control regulation comprises:
selecting a preferred command from the remote cabin control command and the local cabin control command based on a current driving mode of the autonomous vehicle.

11. The autonomous vehicle of claim 1, wherein performing control regulation comprises:
selecting a preferred command from the remote cabin control command and the local cabin control command based on whether the passenger owns the autonomous vehicle.

12. The autonomous vehicle of claim 1, wherein performing control regulation comprises:
selecting a preferred command from the remote cabin control command and the local cabin control command based on weather conditions surrounding the autonomous vehicle.

13. The autonomous vehicle of claim 1, wherein performing control regulation comprises:
selecting a preferred command from the remote cabin control command and the local cabin control command based on a legal regulation.

14. The autonomous vehicle of claim 1, wherein performing control regulation comprises:
selecting a preferred command from the remote cabin control command and the local cabin control command based on a safety compliance rule.

15. The autonomous vehicle of claim 1, wherein performing control regulation comprises:
selecting a preferred command from the remote cabin control command and the local cabin control command based on sensor data collected by sensors of the autonomous vehicle indicating an instant condition surrounding the autonomous vehicle.

16. The autonomous vehicle of claim 1, wherein performing control regulation comprises:
determining a state of the cabin controls;
determining that the remote cabin control command is invalid based on the state of the cabin controls; and
rejecting the remote cabin control command.

17. The autonomous vehicle of claim 1, wherein the cabin controls comprise controls for one or more of: window(s) and door(s) of the autonomous vehicle.

18. The autonomous vehicle of claim 1, wherein the cabin controls comprise controls for one or more of: an air conditioner, a heater, a seat heater, a seat cooler, a seat massager, a window defroster, a vehicle infotainment system, and a touchscreen user interface.

19. A method of managing cabin controls for an autonomous vehicle, comprising:
receiving a remote cabin control command via a wireless communication circuit from a remote autonomous vehicle operator; and
receiving a local cabin control command from a passenger of the autonomous vehicle via a user interface and/or hardware controls;
performing control regulation of the remote cabin control command and the local cabin control command; and
causing actuators to perform a cabin control action in response to a result of the control regulation.

20. One or more tangible, non-transitory computer-readable storage media having stored thereon executable instructions to instruct an autonomous vehicle controller of an autonomous vehicle to:
receive a remote cabin control command via a wireless communication circuit from a remote autonomous vehicle operator; and
receive a local cabin control command from a passenger of the autonomous vehicle via a user interface and/or hardware controls;
perform control regulation of the remote cabin control command and the local cabin control command; and
causing actuators to perform a cabin control action in response to a result of the control regulation.
